(19) United States
(12) Patent Application Publication
(10) Pub. No.: US 2016/0014358 A1
(43) Pub. Date: Jan. 14, 2016

(54) SOLID-STATE IMAGE PICKUP DEVICE AND METHOD OF CONTROLLING SOLID-STATE IMAGE PICKUP DEVICE

(71) Applicant: Kabushiki Kaisha Toshiba, Minato-ku (JP)

(72) Inventor: Shinya ITOH, Oita (JP)

(73) Assignee: Kabushiki Kaisha Toshiba, Minato-ku (JP)

(21) Appl. No.: 14/789,313

(22) Filed: Jul. 1, 2015

(30) Foreign Application Priority Data
Jul. 11, 2014 (JP) 2014-143596

(51) Int. Cl. H04N 5/369; H04N 5/357; H04N 5/355; H04N 5/378; H04N 5/353; H04N 5/3745

(52) U.S. Cl. CPC H04N 5/369; H04N 5/3535; H04N 5/37452; H04N 5/3559; H04N 5/378; H04N 5/357; H04N 2101/00

(57) ABSTRACT

Provided is a method of controlling a solid-state image pickup device according to an embodiment, the method including: resetting a potential of a floating diffusion shared by a plurality of photodiodes; sequentially transferring signal charges, which are photoelectrically converted by the photodiodes, to the floating diffusion in which the potential is reset, in a sequence allocated to the photodiodes, thereby accumulating the transferred signal charges in the floating diffusion; performing a sampling operation on a voltage signal corresponding to the potential of the floating diffusion every time when the signal charge is completely transferred to the floating diffusion from the photodiode; and calculating the voltage signal corresponding to the signal charge transferred to the floating diffusion for each of the photodiodes, based on a difference between two of the voltage signals which are continuously subjected to the sampling operation.

### CROSS-REFERENCE TO RELATED APPLICATIONS

This application is based upon and claims the benefit of priority from Japanese Patent Application No. 2014-143596, filed on Jul. 11, 2014; the entire contents of which are incorporated herein by reference.

### FIELD

The present embodiment generally relates to a solid-state image pickup device and a method of controlling the solid-state image pickup device.

### BACKGROUND

In prior art, there is a solid-state image pickup device in which one floating diffusion (hereinafter, referred to as an “FD”) is shared by a plurality of photodiodes (hereinafter, referred to as a “PDs”). According to the solid-state image pickup device, as compared with a solid-state image pickup device in which the FD is provided in each of the PDs, an occupancy area of the FD can be reduced, so that a light receiving area of each PD can be enlarged to that extent.

In addition, the solid-state image pickup device sequentially repeats a series of signal processing operations with respect to all of the PDs in general, the series of the signal processing operations including: transferring a signal charge accumulated in one PD to the FD after resetting a potential of the FD; and reading out a voltage signal corresponding to the signal charge transferred to the FD.

However, if the potential of the FD is reset whenever the signal charge is transferred to the FD from each of the PDs, the processing operations increase and it takes a long time to finish the readout of the voltage signal with respect to all of the PDs.

### BRIEF DESCRIPTION OF THE DRAWINGS

FIG. 1 is a block diagram illustrating a schematic configuration of a solid-state image pickup device according to a first embodiment;

FIG. 2 is an explanatory diagram illustrating a pixel provided in the solid-state image pickup device illustrated in FIG. 1 when viewed from the top;

FIGS. 3A to 3C are schematic diagrams illustrating the outline of a readout method of reading out pixel signals of the pixel according to the first embodiment, respectively;

FIG. 4 is an explanatory diagram illustrating an example of a circuit configuration of the pixel provided in the solid-state image pickup device according to the first embodiment;

FIG. 5 is a timing chart illustrating a voltage waveform during an operation of each unit in the pixel illustrated in FIG. 4;

FIG. 6 is a flowchart illustrating a processing procedure by which the solid-state image pickup device according to the first embodiment is executed;

FIG. 7 is an explanatory diagram illustrating readout sequence of signal charges accumulated in photodiodes in a pixel array provided in a solid-state image pickup device according to a second embodiment; and

FIGS. 8A to 8C are explanatory diagrams illustrating configuration examples of other pixels provided in a solid-state image pickup device according to the third embodiment, respectively.

### DETAILED DESCRIPTION

In general, according to one embodiment, a method of controlling a solid-state image pickup device includes: resetting a potential of a floating diffusion shared by a plurality of photodiodes; sequentially transferring signal charges, which are photoelectrically converted by the photodiodes, to the floating diffusion in which the potential is reset, in a sequence allocated to the photodiodes, thereby accumulating the transferred signal charges in the floating diffusion; performing a sampling operation on a voltage signal corresponding to the potential of the floating diffusion every time when the signal charge is completely transferred to the floating diffusion from the photodiode; and calculating the voltage signal corresponding to the signal charge transferred to the floating diffusion for each of the photodiodes, based on a difference between two of the voltage signals which are continuously subjected to the sampling operation.

Exemplary embodiments of a solid-state image pickup device and a method of controlling the solid-state image pickup device will be explained below in detail with reference to the accompanying drawings. The invention is not limited to the following embodiments.

### First Embodiment

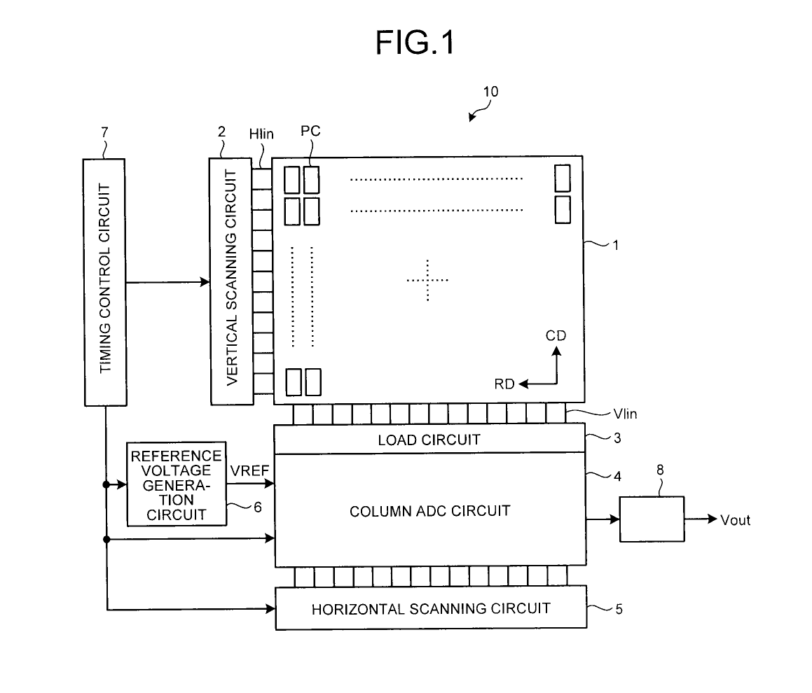

FIG. 1 is a block diagram illustrating a schematic configuration of a solid-state image pickup device 10 according to a first embodiment. As illustrated FIG. 1, the solid-state image pickup device 10 includes a pixel array 1, a vertical scanning circuit 2, a load circuit 3, a column analog digital converter (ADC) circuit 4, a horizontal scanning circuit 5, a reference voltage generation circuit 6, a timing control circuit 7, and a post-stage processor 8.

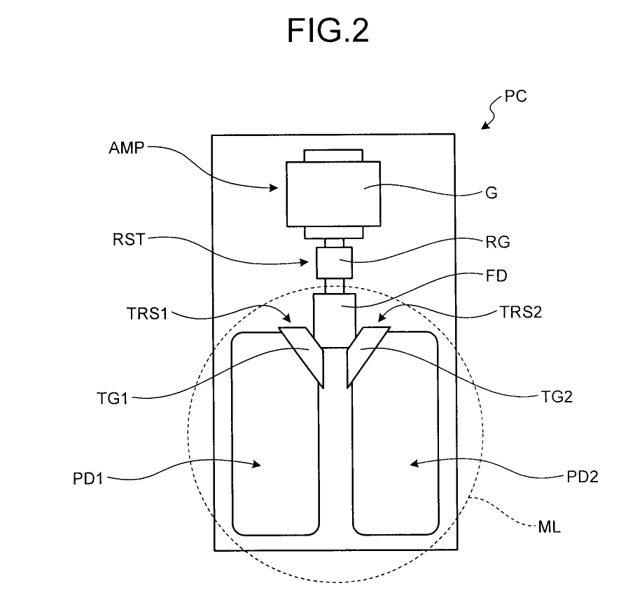

Pixels PCs are arranged in a two-dimensional array (matrix) form in a horizontal direction (row direction) RD and a vertical direction (column direction) CD on the pixel array 1, the pixel performing photoelectric conversion on incident light and accumulating the converted light. The pixel PC corresponds to one pixel of a picked-up image in the pixel array 1. A structure of the pixel PC will be described below with reference to FIG. 2.

In addition, the pixel array 1 is provided with horizontal control lines Hlins, which perform readout control of the pixel PC, in the horizontal direction RD and vertical signal lines Vlins, which transfer a voltage signal read out from the pixel PC, in the vertical direction CD.

The vertical scanning circuit 2 sequentially selects the pixels PCs of a readout object on a row-by-row basis. The load circuit 3 reads out the voltage signal from the pixels PCs for each column of the vertical signal lines Vlins. The column ADC circuit 4 performs a sampling operation on the voltage signal of each pixel PC for each column in correlated double sampling (CDS).

The horizontal scanning circuit 5 sequentially selects the pixels PCs of the readout object on a column-by-column basis. The reference voltage generation circuit 6 outputs a reference voltage VREF to the column ADC circuit 4. The reference voltage VREF is used to compare with the voltage signals which are input to the column ADC circuit 4 through the vertical signal lines Vlins.

The timing control circuit 7 controls readout timing of the voltage signal of each pixel PC with respect to the vertical scanning circuit 2. The post-stage processor 8 calculates a pixel signal based on the sampled voltage signals.

In such a solid-state image pickup device 10, the pixel PC is selected for each row in the vertical direction CD by the vertical scanning circuit 2 and the pixel PC is simultaneously selected for each column in the horizontal direction RD by the horizontal scanning circuit 5. Then, the load circuit 3 performs a source follower operation on the selected pixels PCs and thus the voltage signals read out from the pixels PCs are sent to the column ADC circuit 4 through the vertical signal lines Vlins.

The structure of the pixel PC will be described below with reference to FIG. 2. The pixel PC according to this embodiment has two photodiodes. The solid-state image pickup device 10 provided with such a pixel PC has a function of obtaining a phase difference output by individual sampling of two voltage signals, thereby detecting a focal position of the image and a function of outputting each pixel of the picked-up image by adding these two pixel signals to each other.

FIG. 2 is an explanatory diagram illustrating the pixel PC provided in the solid-state image pickup device 10 of FIG. 1 when viewed from the top. As illustrated in FIG. 2, the pixel PC includes two photodiodes (photoelectric conversion elements) PD1 and PD2 which are electrically separated from each other. In addition, the pixel PC includes one floating diffusion FD provided between two photodiodes PD1 and PD2.

Transfer gates TG1 and TG2 of transfer transistors TRS1 and TRS2 are disposed on a semiconductor layer between the photodiode PD1 and the floating diffusion FD and a semiconductor layer between the photodiode PD2 and the floating diffusion FD, respectively.

In addition, on the semiconductor layer, a gate RG of a reset transistor RST and a gate G of an amplifier transistor AMP are disposed at a region on an opposite side of the photodiodes PD1 and PD2 between which the floating diffusion FD is sandwiched.

In this way, the pixel PC is configured such that two photodiodes PD1 and PD2 share the floating diffusion FD, the reset transistor RST, and the amplifier transistor AMP with each other.

In addition, a microlens ML is provided in the pixel PC to collect incident light on each of the photodiodes PD1 and PD2. The microlens ML is provided to cover a light receiving surface of the photodiode PD1 and a light receiving surface of the photodiode PD2.

In the pixel PC in which one floating diffusion FD is shared by such a plurality of photodiodes PD1 and PD2, a voltage signal corresponding to a signal charge photoelectrically converted by each of the photodiodes PD1 and PD2 is generally sampled as in the following method.

First, after a potential of the floating diffusion FD is reset, a signal charge Q1 accumulated in the photodiode PD1 is transferred to the floating diffusion FD. Then, the solid-state image pickup device 10 performs a sampling operation on a pixel signal S1 serving as the voltage signal corresponding to the potential of the floating diffusion FD in which the signal charge Q1 is accumulated.

Subsequently, the potential of the floating diffusion FD is reset before a signal charge Q2 accumulated in the photodiode PD2 is transferred to the floating diffusion FD. Thereafter, after the signal charge Q2 is transferred, a sampling operation is performed on a pixel signal S2 serving as the voltage signal corresponding to the potential of the floating diffusion FD in which the signal charge Q2 is accumulated.

However, before the transfer of the signal charges Q1 and Q2 which are accumulated in the photodiodes PD1 and PD2, respectively, when the potential of the floating diffusion FD is reset every time, it takes a long time to perform the sampling operation on the pixel signals S1 and S2 of all pixels PCs.

In addition, when the potential of the floating diffusion FD is reset, reset noise “n” due to switching noise of the reset transistor RST enters into the floating diffusion FD in some cases.

Therefore, whenever the potential of the floating diffusion FD is reset, the sampling operation is performed on a reset noise signal N serving as the voltage signal corresponding to the reset noise “n”, and it is necessary to deduct the reset noise signal N from the pixel signals S1 and S2 which will be subjected to the sampling operation later.

Accordingly, even by the sampling of the reset noise signal N and the signal processing of deducting the reset noise signal N from the pixel signals S1 and S2, it takes a long time to perform the sampling operation on the pixel signals S1 and S2 of all pixels PCs. As a result, it takes a long time to read out the pixel signals S1 and S2.

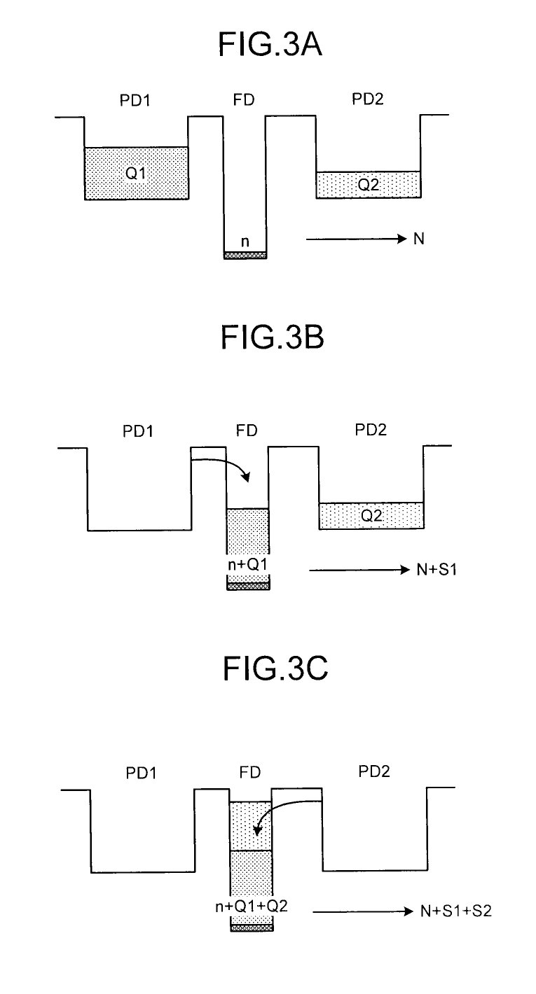

Therefore, in the solid-state image pickup device 10 according to this embodiment, a method of reading out the pixel signals S1 and S2 of the pixels PCs was contrived, so that readout time of the pixel signals S1 and S2 of the pixels PCs was shortened. An outline of a readout method of reading out the pixel signals S1 and S2 of the pixels PCs according to this embodiment will be described below with reference to FIGS. 3A to 3C.

FIGS. 3A to 3C are schematic diagrams illustrating the outline of the readout method of reading out the pixel signals S1 and S2 of the pixels PCs according to the first embodiment, respectively. As illustrated in FIG. 3A, the solid-state image pickup device 10 is in a state where the photoelectrically converted signal charges Q1 and Q2 are accumulated in the photodiodes PD1 and PD2 provided in the pixel PC.

The solid-state image pickup device 10 resets the potential of the floating diffusion FD to a potential of a power-supply voltage in the state where the signal charges Q1 and Q2 are accumulated in the photodiodes PD1 and PD2. At this time, the reset noise “n” as noise caused by the switching of the reset transistor RST enters into the floating diffusion FD, thereby being accumulated and held therein.

Here, the solid-state image pickup device 10 performs a sampling operation on a reset noise signal N serving as the voltage signal corresponding to the potential (reset potential) of the floating diffusion ED in which the reset noise “n” is accumulated, before the signal charge Q1 is transferred to the floating diffusion FD. The reset operation of the potential of the floating diffusion FD and the sampling operation of the reset noise signal N may be performed before the signal charges Q1 and Q2 are accumulated in the photodiodes PD1 and PD2, respectively.

Next, as illustrated in FIG. 3B, the solid-state image pickup device 10 transfers the signal charge Q1 of the photodiode PD1 to the floating diffusion FD in which the reset noise “n” is accumulated. Then, the solid-state image pickup device 10 performs a sampling operation on a voltage signal N+S1 corresponding to the potential of the floating diffusion FD in which the reset noise “n” and the signal charge Q1 are accumulated. The voltage signal N+S1 includes two signal components of the reset noise signal N corresponding to the reset noise “n” and the pixel signal S1 corresponding to the signal charge Q1.

Then, the solid-state image pickup device 10 performs the sampling operation on the voltage signal N+S1 and then calculates a pixel signal S1 not including the component of the reset noise “n” by obtaining a difference between the voltage signal N+S1 and the reset noise signal N.

Next, as illustrated in FIG. 3C, the solid-state image pickup device 10 transfers the signal charge Q2 accumulated in the photodiode PD2 to the floating diffusion FD without resetting the potential of the floating diffusion FD. Thus, the reset noise “n”, the signal charge Q1, and the signal charge Q2 are accumulated and held in the floating diffusion FD.

Then, the solid-state image pickup device 10 performs a sampling operation on a voltage signal N+S1+S2 corresponding to the sum of the reset noise “n”, the signal charge Q1, and the signal charge Q2 which are accumulated in the floating diffusion FD. The voltage signal N+S1+S2 includes three signal components of the reset noise signal N corresponding to the reset noise “n”, the pixel signal S1 corresponding to the signal charge Q1, and the pixel signal S2 corresponding to the signal charge Q2.

Thus, the solid-state image pickup device 10 performs the sampling operation on the voltage signal N+S1+S2 and then can calculate a pixel signal S1+S2 not including the component of the reset noise “n” by obtaining a difference between the voltage signal N+S1+S2 and the reset noise signal N. Moreover, after calculating the pixel signal S1+S2, the solid-state image pickup device 10 can calculate the pixel signal S2 by obtaining a difference between the pixel signal S1+S2 and the pixel signal S1.

After performing the sampling operation on the voltage signal N+S1, the solid-state image pickup device 10 transfers the signal charge Q2 to the floating diffusion FD without resetting the potential of the floating diffusion FD.

In this way, after performing the sampling operation on the voltage signal N+S1, the solid-state image pickup device 10 transfers the signal charge Q2 to the floating diffusion FD without resetting the potential of the floating diffusion FD. For this reason, before transferring the signal charge Q2, the solid-state image pickup device 10 needs not to perform the sampling operation on the reset noise signal N.

Therefore, according to the solid-state image pickup device 10, since the number of reset operations on the potential of the floating diffusion FD and the number of sampling operations on the reset noise signal N can be suppressed, it is possible to shorten the readout time of the pixel signals S1 and S2 of the pixels PCs in the pixel array 1.

Furthermore, since the solid-state image pickup device 10 can calculate the pixel signal S1+S2 corresponding to each pixel of the picked-up image before calculating the pixel signal S2, it is possible to quickly output the picked-up image.

In the solid-state image pickup device 10, when the reset noise “n” entering into the floating diffusion FD due to the reset operation is small enough not to affect the pixel signals S1 and S2, it is possible to omit the sampling operation on the reset noise signal N.

Even in such a case, since the sampling process can be further suppressed in the pixel PC, it is possible to shorten the readout time of the pixel signals S1 and S2 of the pixels PCs in the pixel array 1.

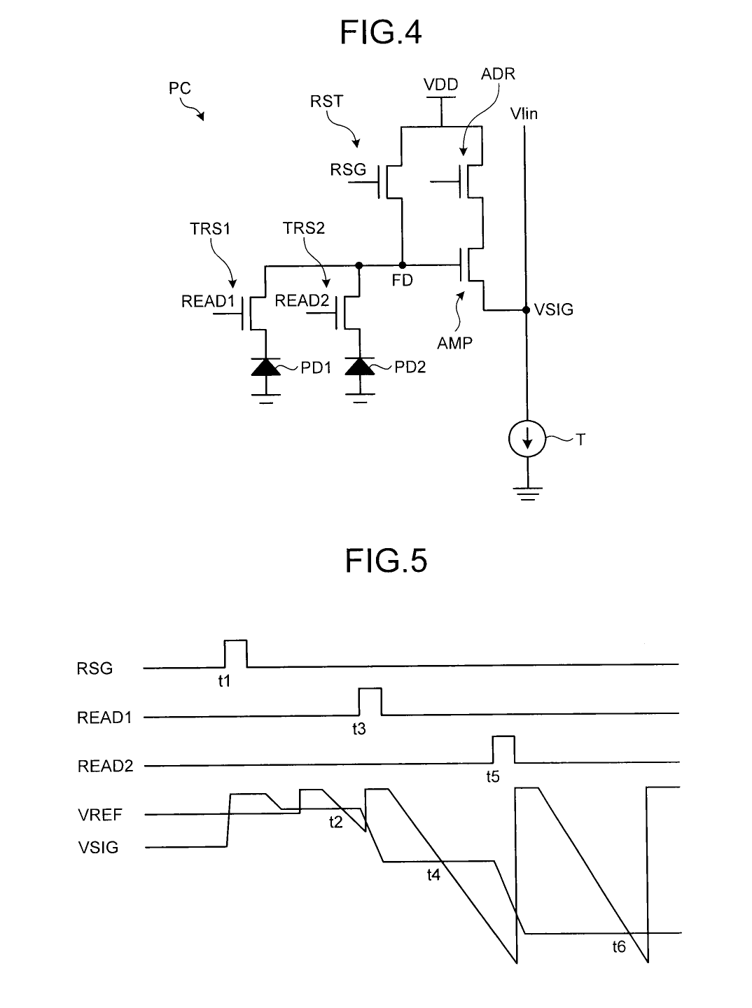

An example of a specific readout method of reading out the pixel signals S1 and S2 from the pixels PCs according to this embodiment will be described below with reference to FIGS. 4 and 5. FIG. 4 is an explanatory diagram illustrating an example of a circuit configuration of the pixel PC provided in the solid-state image pickup device 10 according to the first embodiment. FIG. 5 is a timing chart illustrating a voltage waveform during the operation of each unit in the pixel PC illustrated in FIG. 4.

As illustrated in FIG. 4, the pixel PC includes two photodiodes PD1 and PD2 and two transfer transistors TRS1 and TRS2. Moreover, the pixel PC includes the floating diffusion FD, the amplifier transistor AMP, the reset transistor RST, and an address transistor ADR. These units except for the address transistor ADR have an example of the same physical arrangement as in FIG. 2.

A cathode of each of the photodiodes PD1 and PD2 is connected to a ground and an anode thereof is connected to a source of each of the transfer transistors TRS1 and TRS2. A drain of each of two transfer transistors TRS1 and TRS2 is connected to one floating diffusion FD.

The transfer transistors TRS1 and TRS2 transfer the signal charges Q1 and Q2, which are photoelectrically converted by the photodiodes PD1 and PD2, to the floating diffusion FD, respectively, when transfer signals READ1 and READ2 are input to the transfer gates TG1 and TG2, respectively. A source of the reset transistor RST is connected to the floating diffusion FD.

In addition, a drain of the reset transistor RST is connected to a power-supply voltage line VDD. The reset transistor RST resets the potential of the floating diffusion FD to the potential of the power-supply voltage when a reset signal RSG is input to the gate RG.

In addition, a gate G of the amplifier transistor AMP is connected to the floating diffusion FD. A source of the amplifier transistor AMP is connected to the vertical signal line Vlin and a drain thereof is connected to a source of the address transistor ADR. The vertical signal line Vlin is connected to a current source T. In addition, a drain of the address transistor ADR is connected to a power-supply voltage line VDD.

Such a pixel PC is operated according to the timing chart illustrated in FIG. 5. Here, the description will be based on the state where the signal charges Q1 and Q2 are accumulated in the photodiodes PD1 and PD2, respectively. Furthermore, here, on the assumption that after the reset transistor RST is turned ON at time t1, the transfer transistor TRS1 is turned ON at time t3 and then the transfer transistor TRS2 is turned ON at time t5, the operation of the pixel PC will be described. The times t1, t3, and t5 are known times based on a predetermined clock, respectively.

In the pixel PC, first, as illustrated in FIG. 5, when the reset signal RSG rises at the time t1, the reset signal RSG is input to the gate RG of the reset transistor RST and the potential of the floating diffusion FD is reset to a potential of a power-supply potential.

Then, the voltage of the floating diffusion FD at the time of resetting is applied to the gate G of the amplifier transistor AMP, and a voltage signal VSIG corresponding to the voltage applied to the gate G is input to the column ADC circuit 4 through the vertical signal line Vlin.

Here, as illustrated in FIG. 5, a voltage waveform of the voltage signal VSIG at the time of resetting ascends at the same time the rising of the reset signal RSG, thereby being stabilized. However, the stabilized voltage signal VSIG includes the reset noise “n” caused by the switching noise of the reset transistor RST.

Thereafter, the column ADC circuit 4 compares the voltage waveform of the voltage signal VSIG with a voltage waveform of the reference voltage VREF. Here, the voltage waveform of the reference voltage VREF is a voltage waveform in which a maximum amplitude value and a minimum amplitude value are preset to perform the sampling operation on the reset noise signal N, the voltage signal N+S1, and the voltage signal N+S1+S2, before and after each of the sampling operation.

That is, the reference voltage VREF is a signal to be generated such that a signal level is changed from a state of being higher than the voltage signal VSIG to a state of being lower than the voltage signal VSIG at a period from the time t1 to the time t2, a period from the time t2 to the time t3, and a period after the time t3.

Then, the column ADC circuit 4 performs the sampling operation on the reset noise signal N corresponding to the reset noise “n” held in the floating diffusion FD when the voltage waveform of the reference voltage VREF intersects with the voltage waveform of the voltage signal VSIG at the time t2.

In this way, the column ADC circuit 4 performs the sampling operation on the reset noise signal N at a period from the time t1 at which the potential of the floating diffusion FD is reset to the time at which the transfer transistor TRS1 is turned ON. Then, the column ADC circuit 4 outputs the sampled reset noise signal N to the post-stage processor 8 (see FIG. 1).

Subsequently, in the pixel PC, when the transfer signal READ1 rises at the time t3, the transfer signal READ1 is input to the transfer gate TG1 of the transfer transistor TRS1 and the signal charge Q1 of the photodiode PD1 is transferred to the floating diffusion FD.

Then, the voltage of the floating diffusion FD at the time of transferring the signal charge Q1 is applied to the gate G of the amplifier transistor AMP, and the voltage signal VSIG corresponding to the voltage applied to the gate G is input to the column ADC circuit 4 through the vertical signal line Vlin.

Then, the column ADC circuit 4 compares the voltage waveform of the voltage signal VSIG at the time of transferring the signal charge Q1 with the voltage waveform of the reference voltage VREF. As illustrated in FIG. 5, the voltage waveform of the voltage signal VSIG at the time of transferring the signal charge Q1 further descends as much as a charge amount of the signal charge Q1 from the voltage level descended by the reset noise “n”, thereby being stabilized.

The column ADC circuit 4 performs the sampling operation on the voltage signal N+S1 corresponding to the sum of the reset noise “n” and the signal charge Q1 held in the floating diffusion FD when the voltage waveform of the reference voltage VREF intersects with the voltage waveform of the voltage signal VSIG at time t4.

Then, the column ADC circuit 4 outputs the sampled voltage signal N+S1 to the post-stage processor 8. Thus, the post-stage processor 8 can calculate the pixel signal S1 not including the component of the reset noise “n” by obtaining the difference between the voltage signal N+S1 and the reset noise signal N.

Subsequently, in the pixel PC, as illustrated in FIG. 5, when the transfer signal READ2 rises at time t5, the transfer signal READ2 is input to the transfer gate TG2 of the transfer transistor TRS2 and the signal charge Q2 of the photodiode PD2 is transferred to the floating diffusion FD.

Then, the voltage of the floating diffusion FD at the time of transferring the signal charge Q2 is applied to the gate G of the amplifier transistor AMP, and the voltage signal VSIG corresponding to the voltage applied to the gate G is input to the column ADC circuit 4 through the vertical signal line Vlin.

Thus, in the pixel PC, the signal charge Q2 is continuously transferred to the floating diffusion FD without resetting the floating diffusion FD in which the reset noise “n” and the signal charge Q1 are held.

Then, the column ADC circuit 4 compares the voltage waveform of the voltage signal VSIG at the time of transferring the signal charge Q2 with the voltage waveform of the reference voltage VREF. As illustrated in FIG. 5, the voltage waveform of the voltage signal VSIG at the time of transferring the signal charge Q2 further descends as much as a charge amount of the signal charge Q2 from the voltage level descended by the signal charge Q1, thereby being stabilized.

Then, as illustrated in FIG. 5, the column ADC4 performs the sampling operation on the voltage signal N+S1+S2 corresponding to the sum of the reset noise “n” and the signal charges Q1 and Q2 held in the floating diffusion FD when the voltage waveform of the reference voltage VREF intersects with the voltage waveform of the voltage signal VSIG at time t6.

Then, the column ADC circuit 4 outputs the sampled voltage signal N+S1+S2 to the post-stage processor 8. Thus, the post-stage processor 8 can calculate the pixel signal S1+S2 not including the component of the reset noise “n” by obtaining the difference between the voltage signal N+S1+S2 and the reset noise signal N. Moreover, the post-stage processor 8 can calculate the pixel signal S2 by obtaining the difference between the calculated pixel signal S1+S2 and the pre-calculated pixel signal S1.

In this way, according to the solid-state image pickup device 10, it is possible to calculate the voltage signals S1, S2, and S1+S2 which correspond to the signal charges Q1, Q2, and Q1+Q2, respectively, although the floating diffusion FD is reset only once.

In this embodiment, a method of determining the sampling timing relative to the reset noise signal N, the voltage signal N+S1, and the voltage signal N+S1+S2 by the comparison of the voltage waveform of the reference voltage VREF with the voltage waveform of the voltage signal VSIG is described, but is not limited thereto.

An example of another method of determining the sampling timing is as follow. Since the timing at which the reset signal RSG and the transfer signals READ1 and READ2 rise is known, the sampling timing is set to be newly added to the chart in which such timing is illustrated.

Specifically, in the above-described timing chart, the timing at which the sampling operation is performed on the reset noise signal N is set immediately before the transfer signal READ1 rises, and the timing at which the sampling operation is performed on the voltage signal N+S1 is set immediately before the transfer signal READ2 rises. In addition, the timing at which the sampling operation is performed on the voltage signal N+S1+S2 is set immediately before the next reset signal RSG rises. Such a timing chart is stored in, for example, a memory provided in the column ADC circuit 4.

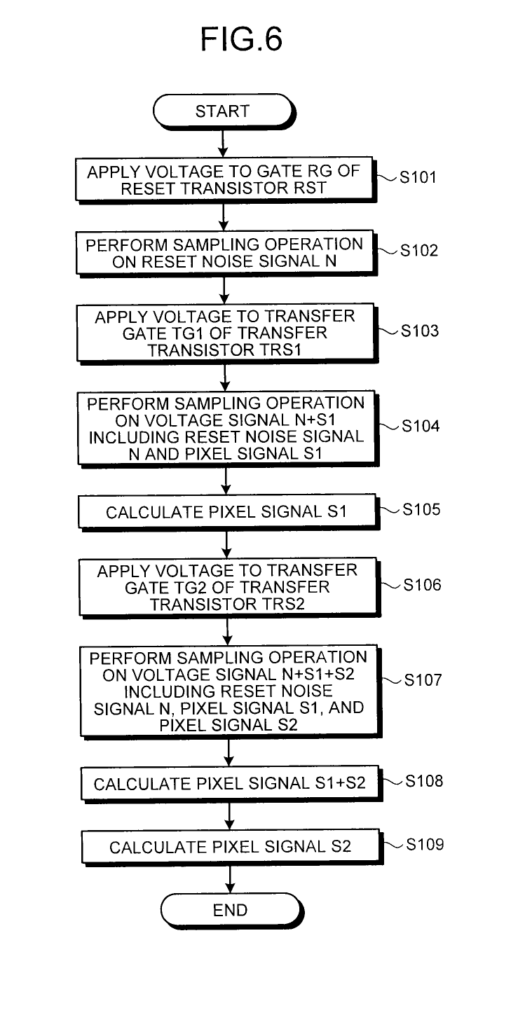

A processing procedure by which the solid-state image pickup device 10 according to this embodiment is executed will be described below with reference to FIG. 6. FIG. 6 is a flowchart illustrating the processing procedure by which the solid-state image pickup device 10 according to the first embodiment is executed.

As illustrated in FIG. 6, first, the solid-state image pickup device 10 applies the voltage to the gate RG of the reset transistor RST (step S101). Subsequently, the solid-state image pickup device 10 performs the sampling operation on the reset noise signal N corresponding to the potential of the floating diffusion FD in which the reset noise “n” is held (step S102).

After such a sampling operation, the solid-state image pickup device 10 applies the voltage to the transfer gate TG1 of the transfer transistor TRS1 (step S103). Subsequently, the solid-state image pickup device 10 performs the sampling operation on the voltage signal N+S1 (including the reset noise signal N and the pixel signal S1) corresponding to the potential of the floating diffusion FD in which the reset noise “n” and the signal charge Q1 are held (step S104).

After such a sampling operation, the solid-state image pickup device 10 calculates the pixel signal S1 not including the component of the reset noise “n” by obtaining the difference between the voltage signal N+S1 and the reset noise signal N (step S105).

After such a calculation, the solid-state image pickup device 10 applies the voltage to the transfer gate TG2 of the transfer transistor TRS2 (step S106). Subsequently, the solid-state image pickup device 10 performs the sampling operation on the voltage signal N+S1+S2 (including the reset noise signal N, the pixel signal S1, and the pixel signal S2) corresponding to the potential of the floating diffusion FD in which the reset noise “n”, the signal charge Q1, and the signal charge Q2 are held (step S107).

After such a sampling operation, the solid-state image pickup device 10 calculates the pixel signal S1+S2 not including the component of the reset noise “n” by obtaining the difference between the voltage signal N+S1+S2 and the reset noise signal N (step S108).

After such a calculation, the solid-state image pickup device 10 calculates the pixel signal S2 by obtaining the difference between the pixel signal S1+S2 and the pixel signal S1 (step S109), and thus the processing is completed.

In this way, after performing the sampling operation on the voltage signal N+S1, the solid-state image pickup device 10 transfers the signal charge Q2 to the floating diffusion FD without resetting the potential of the floating diffusion FD. Therefore, the solid-state image pickup device 10 needs not to perform the sampling operation on the reset noise signal N before transferring the signal charge Q2.

Therefore, according to the solid-state image pickup device 10, since the number of reset operations on the potential of the floating diffusion FD and the number of sampling operations on the reset noise signal N can be suppressed, it is possible to shorten the readout time of the pixel signals S1 and S2.

Furthermore, since the solid-state image pickup device 10 can calculate the pixel signal S1+S2 corresponding to each pixel of the picked-up image before calculating the pixel signal S2, it is possible to quickly output the picked-up image.

In the solid-state image pickup device 10, when the reset noise “n” entering into the floating diffusion FD due to the reset operation is small enough not to affect the pixel signals S1 and S2, it is possible to omit the sampling operation on the reset noise signal N.

Even in such a case, since the number of reset operations on the potential of the floating diffusion FD and the number of sampling operations on the reset noise signal N can be further suppressed, it is possible to shorten the readout time of the pixel signals S1 and S2 of the pixels PCs in the pixel array 1.

### Second Embodiment

A second embodiment will be described below. In the solid-state image pickup device 10 according to the first embodiment, the signal charge Q1 of the photodiode PD1 is transferred to the floating diffusion FD, and then the signal charge Q2 of the photodiode PD2 is transferred to the floating diffusion FD.

In the solid-state image pickup device 10, for example, when unexpected intense light is incident on the photodiodes PD1 and PD2, if the signal charge Q2 is transferred to the floating diffusion FD in which the signal charge Q1 is held, there is a concern that the floating diffusion FD is in a saturated state.

In solid-state image pickup device 10 under such exceptional circumstances, some of the signal charge Q2 can overflow from the floating diffusion FD or can remain in the PD2 without being transferred, so that there is a concern that reliable pixel signal S2 is not obtained.

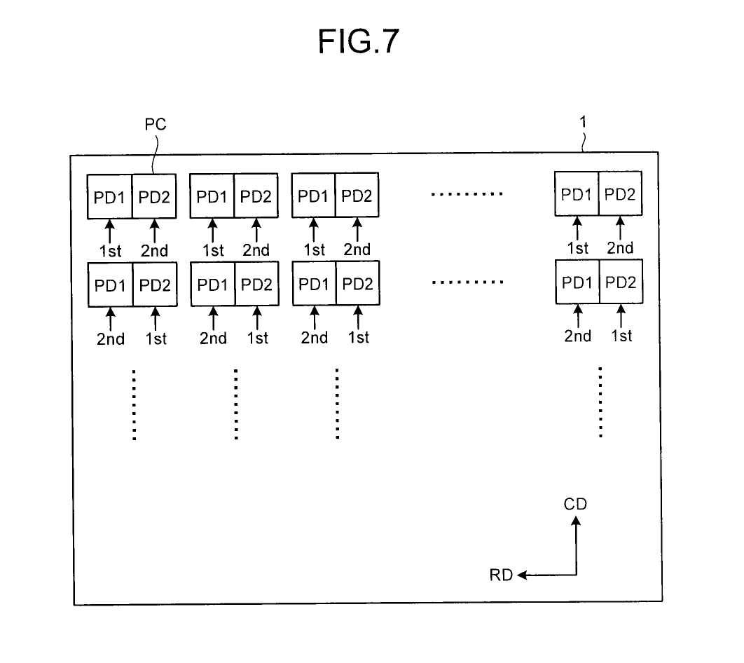

Therefore, in the solid-state image pickup device according to the second embodiment, the readout sequence of the signal charges Q1 and Q2 accumulated in the photodiodes PD1 and PD2 in the pixel array 1 is interchanged for each row, and thus the reliable pixel signals S1 and S2 are selectively obtained. Such a readout sequence will be described with reference to FIG. 7.

FIG. 7 is an explanatory diagram illustrating the readout sequence of the signal charges Q1 and Q2, which are accumulated in the photodiodes PD1 and PD2, respectively, in the pixel array 1 provided in the solid-state image pickup device according to the second embodiment.

As illustrated in FIG. 7, in the solid-state image pickup device according to the second embodiment, for example, the readout is first performed on the signal charge Q1 of the photodiode PD1 in a pixel PC of e firs row and then the readout is performed on the signal charge Q2 of the photodiode PD2 therein.

Here, in the solid-state image pickup device according to the second embodiment, a detector (not illustrated) determines whether the floating diffusion FD is in the saturated state. Specifically, if a voltage waveform of a voltage signal VSIG is not inverted even when a voltage waveform of a reference voltage VREF descends up to a minimum amplitude value, the detector determines that the floating diffusion FD is in the saturated state.

Then, in the solid-state image pickup device according to the second embodiment, when the detector determines that the floating diffusion FD is in the saturated state, the readout is first performed on the signal charge Q2 of the photodiode PD2 in a pixel PC of a second row and then the readout is performed on the signal charge Q1 of the photodiode PD1 therein.

In this way, the solid-state image pickup device according to the second embodiment changes the sequence of the photodiodes PD1 and PD2 for performing the readout of the signal charges Q1 and Q2, based on the determination of the detector, and thus can selectively read out the reliable pixel signals S1 and S2.

Thus, the solid-state image pickup device according to the second embodiment, for example, reads out the reliable pixel signal S1 from the pixel PC of the first row, reads out the reliable pixel signal S2 from the pixel PC of the second row, and can calculate the reliable output pixel from the sum of these pixel signals S1 and S2.

### Third Embodiment

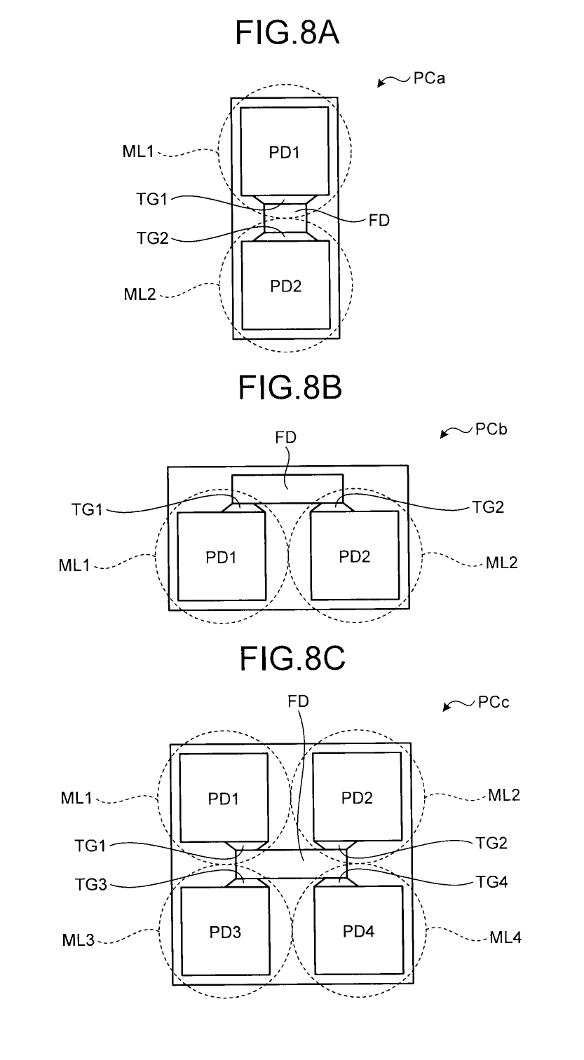

A third embodiment will be described below. The solid-state image pickup device 10 according to the first embodiment is configured such that two photodiodes PD1 and PD2 are disposed inside one microlens ML in a plan view, but is not limited to this configuration. Configuration examples of other pixels will be described with reference to FIGS. 8A to 8C.

FIGS. 8A to 8C are an explanatory diagram illustrating configuration examples of other pixels provided in a solid-state image pickup device according to the third embodiment, respectively. Components having the same function as the pixel PC illustrated in FIG. 2 are denoted by the same reference numerals as in FIG. 2, and other components will not be presented for convenience of explanation.

A pixel PCa illustrated in FIG. 8A has a configuration in which two photodiodes PD1 and PD2 are vertically disposed in a plan view and microlenses ML1 and ML2 are provided for the photodiodes PD1 and PD2, respectively. Furthermore, in the pixel PCa, one floating diffusion FD is provided between two photodiodes PD1 and PD2 which are vertically arranged. The floating diffusion FD is shared by the photodiodes PD1 and PD2.

Since the pixel PCa is configured such that the photodiodes PD1 and PD2 are vertically disposed with the floating diffusion FD therebetween, it is used as a phase difference detection pixel.

Even in the pixel PCa, a sampling operation of a reset noise signal N, a sampling operation of a voltage signal N+S1, and a sampling operation of a voltage signal N+S1+S2 are sequentially performed in the same processing procedure as the processing procedure to be executed by the solid-state image pickup device 10 according to the first embodiment.

Therefore, even when reading out a phase difference pixel in a vertical direction, the pixel PCa can shorten readout time of the pixel signals S1 and S2.

In addition, a pixel PCb illustrated in FIG. 8B has a configuration in which two photodiodes PD1 and PD2 are transversely disposed in a plan view and microlenses ML1 and ML2 are provided for the photodiodes PD1 and PD2, respectively. Furthermore, in the pixel PCb, one floating diffusion FD is provided next two photodiodes PD1 and PD2 which are transversely arranged. The floating diffusion FD is shared by the photodiodes PD1 and PD2.

Such a structure of the pixel PCb is a two-pixel one-cell structure in which one floating diffusion FD is shared by two photodiodes PD1 and PD2. Even in the pixel PCb, a sampling operation of a reset noise signal N, a sampling operation of a voltage signal N+S1, and a sampling operation of a voltage signal N+S1+S2 are sequentially performed in the same processing procedure as the processing procedure to be executed by the solid-state image pickup device 10 according to the first embodiment.

Therefore, even being formed with the two-pixel one-cell structure, the pixel PCb can shorten readout time of the pixel signals S1 and S2.

The pixel PCb may have a configuration in which a half of a light receiving surface of each of the photodiodes PD1 and PD2 is covered with a light shielding film. Even in the pixel PCb, it is possible to detect the phase difference of light received by the photodiodes PD1 and PD2 and can shorten the readout time of the pixel signals S1 and S2.

A pixel PCc illustrated in FIG. 8C has a configuration in which four photodiodes PD1, PD2, PD3, and PD4 surround peripheries of one floating diffusion FD in a plan view. Furthermore, in the pixel PCc, microlenses ML1, ML2, ML3, and ML4 are provided for the photodiodes PD1, PD2, PD3, and PD4, respectively.

The structure of the pixel PCc is a four-pixel one-cell structure in which one floating diffusion FD2 is shared by four photodiodes PD1, PD2, PD3, and PD4.

In the pixel PCc, after a sampling operation of a reset noise signal N is performed, a signal charge Q1 of the photodiode PD1 is transferred to the floating diffusion FD. Then, the pixel PCc performs a sampling operation on a voltage signal N+S1 corresponding to a potential of the floating diffusion FD including a reset noise “n” and the signal charge Q1.

Then, the pixel PCc also performs the transfer of the signal charge and the sampling operation of the voltage signal in the same manner even in each of the photodiodes PD2, PD3, and PD4 without resetting the potential of the floating diffusion FD before the transfer of the signal charge.

Accordingly, even being formed with the four-pixel one-cell structure, the pixel PCc can shorten readout time of pixel signals S1, S2, S3, and S4.

In addition, since the pixel PCc is configured such that one floating diffusion FD is shared by four photodiodes PD1, PD2, PD3, and PD4, laying regions of the photodiodes can be increased. Accordingly, the pixel PCc can largely set an area of the light receiving surface of each of the photodiodes PD1, PD2, PD3, and 294.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of controlling a solid-state image pickup device, comprising:
resetting a potential of a floating diffusion shared by a plurality of photodiodes;
sequentially transferring signal charges, which are photoelectrically converted by the photodiodes, to the floating diffusion in which the potential is reset, in a sequence allocated to the photodiodes, thereby accumulating the transferred signal charges in the floating diffusion;
performing a sampling operation on a voltage signal corresponding to the potential of the floating diffusion every time when the signal charge is completely transferred to the floating diffusion from one of the photodiodes; and
calculating the voltage signal corresponding to the signal charge transferred to the floating diffusion for each of the photodiodes, based on a difference between two of the voltage signals which are continuously subjected to the sampling operation.

2. The method of controlling a solid-state image pickup device according to claim 1, further comprising:
performing a sampling operation on a voltage signal corresponding to the reset potential when the potential of the floating diffusion is reset.

3. The method of controlling a solid-state image pickup device according to claim 1, further comprising:
resetting the potential of the floating diffusion when the signal charges are transferred to the floating diffusion from all of the photodiodes that share the floating diffusion.

4. The method of controlling a solid-state image pickup device according to claim 1, further comprising:
changing the sequence of the photodiodes by which the signal charges are transferred to the floating diffusion when the floating diffusion is saturated by the signal charges.

5. The method of controlling a solid-state image pickup device according to claim 4, wherein the signal charges are transferred to the floating diffusion from the photodiodes for each row of the floating diffusion arrayed in a matrix form, and
the changing of the sequence of the photodiodes, by which the signal charges are transferred, is performed in the case of transferring the signal charges to the floating diffusion in a row next to the row of the floating diffusion in which the floating diffusion is saturated by the signal charges.

6. The method of controlling a solid-state image pickup device according to claim 1, wherein the potential of the floating diffusion is reset to a potential of a power-supply voltage.

7. The method of controlling a solid-state image pickup device according to claim 2, further comprising:
obtaining a difference between the voltage signal corresponding to the reset potential when the potential of the floating diffusion is reset and the voltage signal when an initial signal charge is transferred to the floating diffusion in which the potential is reset.

8. A method of controlling a solid-state image pickup device, comprising:
resetting a potential of a floating diffusion shared by a first photodiode and a second photodiode;
transferring a first signal charge, which is photoelectrically converted by the first photodiode, to the floating diffusion in which the potential is reset, thereby accumulating the transferred first signal charge in the floating diffusion;
performing a sampling operation on a voltage signal corresponding to the first signal charge accumulated in the floating diffusion;
transferring a second signal charge, which is photoelectrically converted by the second photodiode, to the floating diffusion in which the first signal charge is accumulated, thereby accumulating the transferred second signal charge in the floating diffusion;
performing a sampling operation on voltage signal corresponding to the first signal charge and the second signal charge that are accumulated in the floating diffusion; and
calculating the voltage signal corresponding to the second signal charge, based on a difference between two of the voltage signals which are continuously subjected to the sampling operation.

9. The method of controlling a solid-state image pickup device according to claim 8, further comprising:
performing a sampling operation on a voltage signal corresponding to the reset potential when the potential of the floating diffusion is reset.

10. The method of controlling a solid-state image pickup device according to claim 9, further comprising:
obtaining a difference between the voltage signal corresponding to the reset potential when the potential of the floating diffusion is reset and the voltage signal when the first signal charge is transferred to the floating diffusion in which the potential is reset.

11. The method of controlling a solid-state image pickup device according to claim 8, further comprising:
changing the sequence of the first photodiode and the second photodiode by which the signal charges are transferred to the floating diffusion when the floating diffusion is saturated by the first signal charge and the second signal charge.

12. The method of controlling a solid-state image pickup device according to claim 11, wherein the first signal charge and the second signal charge are transferred to the floating diffusion from the first photodiode and the second photodiode for each row of the floating diffusion arrayed in a matrix form, and
the changing of the sequence of the first photodiode and the second photodiode, by which the signal charges are transferred, is performed in the case of transferring the signal charges to the floating diffusion in a row next to the row of the floating diffusion in which the floating diffusion is saturated by the first signal charge and the second signal charge.

13. A solid-state image pickup device comprising:
a reset processor that resets a potential of a floating diffusion shared by a plurality of photodiodes;
a transfer processor that sequentially transfers signal charges, which are photoelectrically converted by the photodiodes, to the floating diffusion in which the potential is reset, in a sequence allocated to the photodiodes, thereby accumulating the transferred signal charges in the floating diffusion;
a sampling processor that performs a sampling operation on a voltage signal corresponding to the potential of the floating diffusion every time when the signal charge is completely transferred to the floating diffusion from one of the photodiodes; and
a calculation processor that calculates the voltage signal corresponding to the signal charge transferred to the floating diffusion for each of the photodiodes, based on a difference between two of the voltage signals which are continuously subjected to the sampling operation.

14. The solid-state image pickup device according to claim 13, wherein the sampling processor performs a sampling operation on a voltage signal corresponding to the reset potential when the potential of the floating diffusion is reset.

15. The solid-state image pickup device according to claim 13, wherein the reset processor resets the potential of the floating diffusion when the signal charges are transferred to the floating diffusion from all of the photodiodes that share the floating diffusion.

16. The solid-state image pickup device according to claim 13, further comprising:
a detector that changes the sequence of the photodiodes by which the signal charges are transferred to the floating diffusion when the floating diffusion is saturated by the signal charges.

17. The solid-state image pickup device according to claim 13, wherein the reset processor resets the potential of the floating diffusion to a potential of a power-supply voltage.

18. The solid-state image pickup device according to claim 14, wherein the calculation processor obtains a difference between the voltage signal corresponding to the reset potential when the potential of the floating diffusion is reset and the voltage signal when an initial signal charge is transferred to the floating diffusion in which the potential is reset.
